(19) United States
(12) Patent Application Publication
(10) Pub. No.: US 2004/0128218 A1
(43) Pub. Date: Jul. 1, 2004

(54) System and method for managing accounts receivable

(76) Inventor: Juei-Mei Wang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/666,004

(22) Filed: Sep. 17, 2003

(30) Foreign Application Priority Data
Dec. 25, 2002 (TW) 91137237

(51) Int. Cl. G06F 17/60

(52) U.S. Cl. 705/35

(57) ABSTRACT

A system and method for managing accounts receivable according to sales data and delivery data obtained from external systems. The system includes a database server (3) for storing accounts receivable data; an application server (2) electrically connected with the database server for accessing and processing data stored in the database server; and a plurality of client computers (1) electrically connected to the application server for downloading data from and uploading data to the database server. The application server includes a data obtaining module (200) for obtaining data from external systems, a sales return managing module (202) for managing accounting operations related to sales return, a sales discount managing module (204) for managing accounting operations related to sales discount, an accounts receivable managing module (208) for managing and updating the accounts receivable data stored in the database server, and an account booking module (210) for automatically generating accounting entries.

### BACKGROUND OF THE INVENTION

1. Field of the Invention

This invention relates to systems and methods for managing accounts receivable, and more particularly to a system and method which can automatically conduct accounting operations related to accounts receivable according to sales data and delivery data obtained from external systems.

2. Description of Related Art

The effective management of accounts receivable is always an important subject of financial management of an enterprise. Nowadays, there are many computer systems developed for managing accounts receivable, mainly focusing on automatic booking and recording of accounting entries. Such computer systems make some improvements on reducing workload and human error. However, the efficient recovery and control of accounts receivable are still problematic.

In addition, nowadays, computer systems for accounts receivable management are generally connected with a financial management system, but are seldom directly connected with production or sales management systems. Manual work is required for integrating production or sales data with financial data. Moreover, special events that occur in a sales transaction, such as a sales return or a sales discount, cannot be automatically processed by a conventional financial management system.

U.S. patent application Publication No. 2002/0077972, published on Jun. 20^{th}, 2002, discloses a method and means for an on-line accounts receivable management system. The system of the invention can timely track current accounts receivable (AR) via a central server connecting with computer systems of banks and an AR agent whose business is to help enterprises recover their accounts receivable. Said system is directed to solving the problem of how to track and recover accounts receivable when excesses of accounts receivable occur. However, said system does not adequately address the other problems mentioned above.

Accordingly, what is needed is a system and method which can overcome all the above-mentioned problems.

### SUMMARY OF THE INVENTION

A primary object of the present invention is to provide a system which can automatically conduct accounting operations related to accounts receivable according to sales data and delivery data obtained from external systems.

Another object of the present invention is to provide a method which can automatically conduct accounting operations related to accounts receivable according to sales data and delivery data obtained from external systems.

A further object of the present invention is to provide a method which can automatically conduct accounting operations related to accounts receivable when a sales return occurs or a sales discount applies.

In one aspect of the present invention, a system for managing accounts receivable is provided. The system comprises a database server for storing accounts receivable data; an application server electrically connected with the database server for accessing and processing data stored in the database server, the application server comprising a data obtaining module for obtaining data from external systems, a sales return managing module for managing accounting operations related to sales return, a sales discount managing module for managing accounting operations related to sales discount, an accounts receivable managing module for managing and updating the accounts receivable data stored in the database server, and an account booking module for automatically generating accounting entries; and a plurality of client computers electrically connected to the application server for downloading data from and uploading data to the database server.

In another aspect of the present invention, a method for managing accounts receivable is provided. The method comprises the steps of: obtaining a customer's purchase order data; retrieving advance payment data related to the purchase order according to the obtained purchase order data; obtaining a delivery message showing that the purchase order is fulfilled; calculating an account receivable of the purchase order; generating a sales invoice of the purchase order according to the calculated account receivable and the advance payment data; and generating one or more accounting entries according to the calculated account receivable and the advance payment data.

In a further aspect of the present invention, another method for managing accounts receivable is provided. The method comprises the steps of: confirming fulfillment of a purchase order released by a customer according to a delivery message related to the purchase order; determining whether a sales return has occurred on the purchase order; determining whether the purchase order has a sales discount if no sales return has occurred, and generating accounting entries for the sales discount if the purchase order has a sales discount; determining whether the customer has accepted an alternative arrangement for the purchase order if a sales return has occurred, and reconfirming fulfillment of the purchase order if the customer has accepted the alternative arrangement; canceling one or more sales invoices related to the purchase order if the customer has not accepted the alternative arrangements; balancing one or more accounts receivable related to the purchase order; and generating accounting entries for the sales return.

Other objects, advantages and novel features of the present invention will be drawn from the following detailed description of the present invention with attached drawings, in which:

### BRIEF DESCRIPTION OF THE DRAWINGS

FIG. 1 is a schematic diagram of hardware infrastructure of a system for managing accounts receivable, according to a preferred embodiment of the present invention;

FIG. 2 is a block diagram showing main function modules of an application server of the system of FIG. 1;

FIG. 3 is a flowchart for automatically confirming accounts receivable of a purchase order released by a customer, in accordance with the present invention; and

FIG. 4 is a flowchart for managing accounts receivable when a sales return occurs or a sales discount applies, in accordance with the present invention.

### DETAILED DESCRIPTION OF THE INVENTION

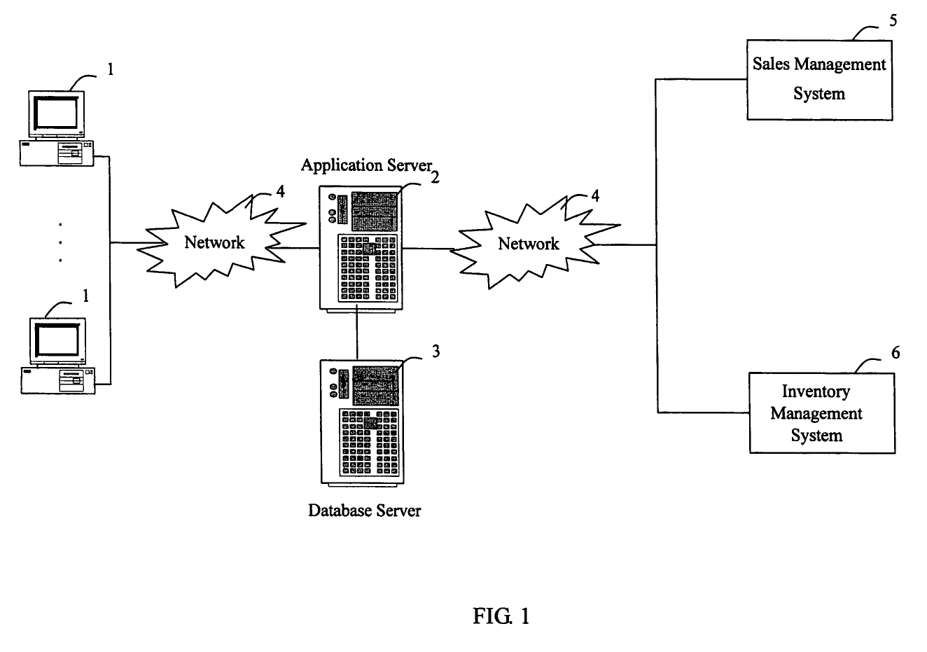

FIG. 1 is a schematic diagram of hardware infrastructure of a system for managing accounts receivable, according to the preferred embodiment of the present invention. The hardware infrastructure comprises a database server 3, an application server 2, and a plurality of client computers 1. The database server 2 stores accounts receivable data of an enterprise. The application server 2 can electronically visit a sales management system 5 and an inventory management system 6 and retrieve data therefrom via a communications network 4. The sales management system 5 is used for managing and storing sales data of the enterprise, the sales data comprising sales records, sales revenue, accounts receivable and so on. The inventory management system 6 is used for managing and storing current inventory data and delivery records. Each client computer 1 can visit the application server 2 via the communications network 4, and further access data stored in the database server 3 via the application server 2. The communications network 4 can be the Internet or an intranet.

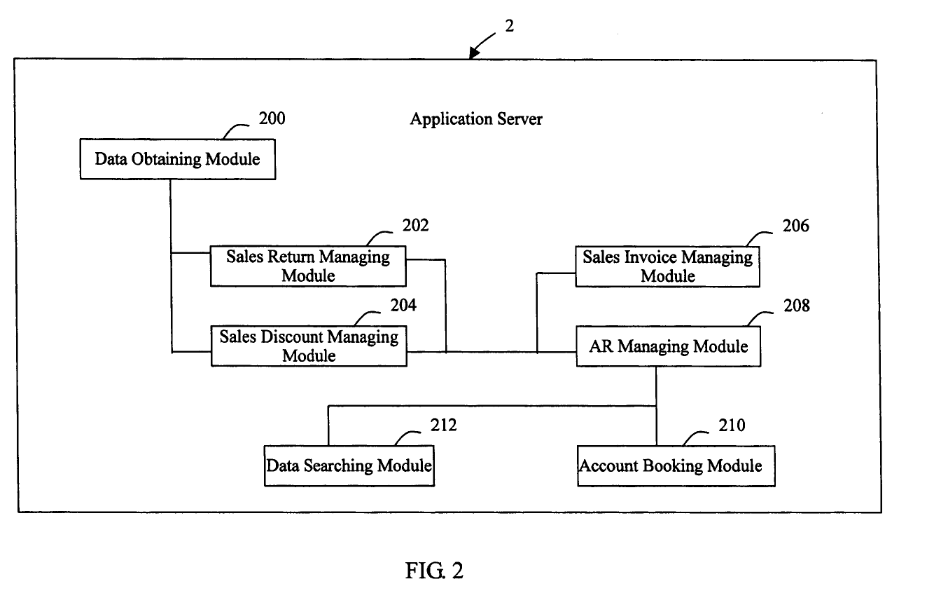

FIG. 2 is a block diagram showing main function modules of the application server 2. The application server 2 comprises a data obtaining module 200, a sales return managing module 202, a sales discount managing module 204, a sales invoice managing module 206, an accounts receivable (AR) managing module 208, an account booking module 210, and a data searching module 212.

The data obtaining module 200 is for retrieving data from the sales management system 5 and the inventory management system 6 via the communications network 4.

The sales return managing module 202 is for managing sales returns according to sales return data obtained from the sales management system 5.

The sales discount managing module 204 is for managing sales discounts according to sales discount data obtained from the sales management system 5. Sales discounts typically comprise different discount types and discount rates, and the particular discount terms are recorded for each purchase order (P.O.). The sales discount managing module 204 can automatically calculate a discount of each purchase order according to the corresponding discount terms.

The sales invoice managing module 206 is for generating sales invoices when a purchase order released by a customer is fulfilled. In the preferred embodiment of the present invention, when the data obtaining module 200 obtains a delivery message from the inventory management system 6 showing that a purchase order is fulfilled, the sales invoice managing module 206 automatically generates a sales invoice according to the purchase order data. When there is a sales return or a sales discount related to the purchase order, the sales invoice managing module 206 can cancel or modify the original sales invoice accordingly.

The AR managing module 208 is for managing accounts receivable data stored in the database server 3. When a delivery message released from the inventory management system 6 shows that a purchase order is fulfilled, the account receivable related to the purchase order is confirmed and the account receivable data are updated in the database server 3. If a sales return occurs or a sales discount applies, the AR managing module 208 automatically updates account receivable data in the database server 3.

The account booking module 210 is for automatically generating relevant accounting entries of sales transactions.

The data searching module 212 is provided for users to search accounts receivable data and relevant accounting entries.

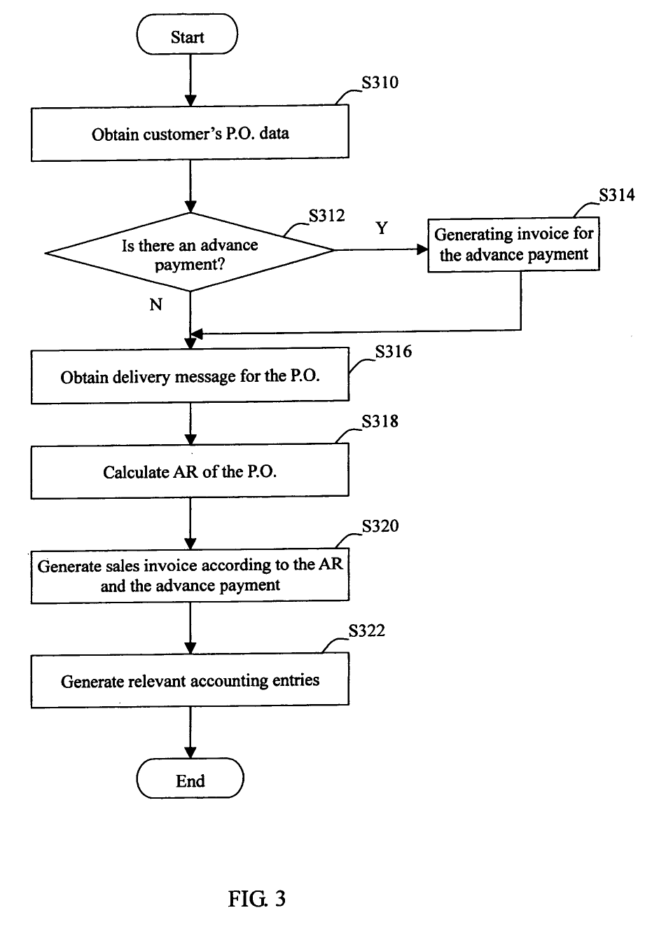

FIG. 3 is a flowchart for automatically confirming an account receivable of a purchase order released by a customer, in accordance with the present invention. In step S310, the data obtaining module 200 obtains a customer's purchase order data from the sales management system 5. In step S312, the application server 2 determines whether there is an advance payment related to the purchase order. If the purchase order has an advance payment, in step S314, the sales invoice managing module 206 automatically generates an invoice for the advance payment, whereupon the procedure proceeds to step S316. If the purchase order does not have an advance payment, in step S316, the data obtaining module 200 obtains a delivery message related to the purchase order from the inventory management system 6 to confirm that the purchase order is fulfilled. In step S318, the AR managing module 208 of the application server 2 automatically calculates an account receivable related to the purchase order. More than one account receivable related to the purchase order may need to be calculated. However, for the sake of simplicity, it will be assumed hereafter that only one account receivable is calculated. In step S320, the sales invoice managing module 206 generates a sales invoice for the purchase order according to the calculated account receivable and the advance payment. In step S322, the account booking module 210 automatically generates relevant accounting entries for the above transaction.

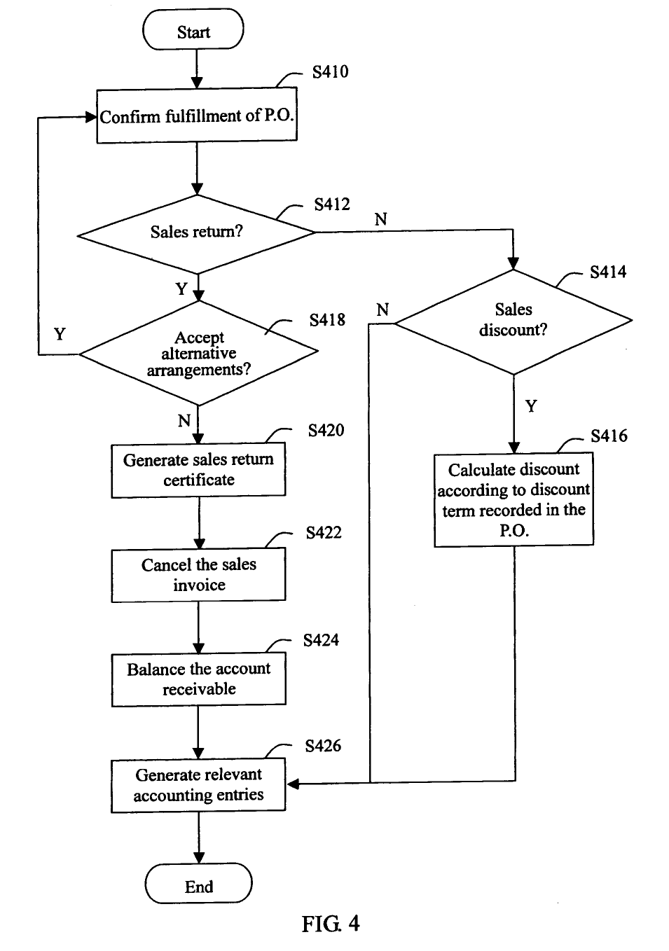

FIG. 4 is a flowchart for managing an account receivable when a sales return occurs or a sales discount applies, in accordance with the present invention. In step S410, the application server 2 confirms that a purchase order is fulfilled according to a delivery message of the purchase order obtained from the inventory management system 6. In step S412, the sales return managing module 202 determines whether there is a sales return related to the purchase order. Generally, when a sales return occurs, the data obtaining module 200 obtains a message from the inventory management system 6 showing that the cargo ordered is returned.

If there is no sales return, in step S414, the sales discount managing module determines whether the purchase order has a sales discount. Sales discount information is obtained from discount terms recorded in the purchase order. If no sales discount applies, in step S426, the account booking module 210 generates accounting entries related to the purchase order. If a sales discount applies, in step S416, the sales discount managing module 204 calculates a discount according to the discount terms recorded in the purchase order, and then in step S426, the account booking module 210 automatically generates accounting entries related to the sales discount.

If a sales return occurs, in step S418, the application server 2 checks whether the customer has accepted alternative arrangements for the purchase order. If the customer has accepted alternative arrangements, the procedure returns to step S410 in which the application server 2 reconfirms fulfillment of the purchase order. If the customer has not accepted alternative arrangements, in step S420, the sales return managing module 202 generates a sales return certificate to confirm the sales return. In step S422, the sales invoice managing module 206 automatically cancels the sales invoice of the purchase order. In step S424, the AR managing module 208 balances the account receivable related to the purchase order. More than one account receivable related to the purchase order may need to be balanced. However, for the sake of simplicity, it is assumed herein that only one account receivable is balanced. In step S426, the account booking module 210 generates accounting entries related to the sales return.

The preferred embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims which follow and their equivalents.

What is claimed is:

1. A system for managing accounts receivable, the system comprising:
a database server for storing accounts receivable data;
an application server electrically connected with the database server for accessing and processing data stored in the database server, the application server comprising a data obtaining module for obtaining data from external systems, a sales return managing module for managing accounting operations related to sales returns, a sales discount managing module for managing accounting operations related to sales discounts, an accounts receivable managing module for managing and updating the accounts receivable data stored in the database server, and an account booking module for automatically generating accounting entries; and
a plurality of client computers electrically connected to the application server for downloading data from and uploading data to the database server.

2. The system as claimed in claim 1, wherein the application server further comprises a data searching module for users to search the accounts receivable data and accounting entries data.

3. The system as claimed in claim 1, wherein the application server further comprises a sales invoice managing module for managing sales invoices related to accounts receivable.

4. The system as claimed in claim 1, wherein the application server electrically connects with a sales management system for accessing sales data stored in the sales management system and updating the accounts receivable data in the database server accordingly.

5. The system as claimed in claim 1, wherein the application server electrically connects with an inventory management system for accessing delivery data stored in the inventory management system.

6. A method for managing accounts receivable, the method comprising the steps of:
obtaining a customer's purchase order data;
retrieving advance payment data related to the purchase order according to the obtained purchase order data;
obtaining a delivery message showing that the purchase order is fulfilled;
calculating an account receivable of the purchase order;
generating a sales invoice of the purchase order according to the calculated account receivable and the advance payment data; and
generating one or more accounting entries according to the calculated account receivable and the advance payment data.

7. The method as claimed in claim 6, further comprising the step of generating an invoice according to the retrieved advance payment data.

8. A method for managing accounts receivable, the method comprising the steps of:
confirming fulfillment of a purchase order released by a customer according to a delivery message related to the purchase order;
determining whether a sales return has occurred on the purchase order;
determining whether the purchase order has a sales discount if no sales return has occurred, and generating accounting entries for the sales discount if the purchase order has a sales discount;
determining whether the customer has accepted an alternative arrangement for the purchase order if a sales return has occurred, and reconfirming fulfillment of the purchase order if the customer has accepted the alternative arrangement;
canceling one or more sales invoices related to the purchase order if the customer has not accepted the alternative arrangements;
balancing one or more accounts receivable related to the purchase order; and
generating accounting entries for the sales return.

9. The method as claimed in claim 8, further comprising the step of calculating a discount according to discount terms recorded in the purchase order.

10. The method as claimed in claim 8, further comprising the step of generating a sales return certificate for the purchase order.

11. The method as claimed in claim 8, wherein the delivery message is obtained from an inventory management system.
